(19) United States
(12) Patent Application Publication
(10) Pub. No.: US 2026/0019157 A1
(43) Pub. Date: Jan. 15, 2026

(54) OPTICAL TRANSMISSION DEVICE AND OPTICAL TRANSMISSION METHOD

(71) Applicant: Fujitsu Limited, Kawasaki-shi (JP)

(72) Inventors: Ichiro YOKOKURA, Sano (JP); Yusuke TANABE, Sendai (JP); Junichi SUGIYAMA, Kawasaki (JP); KAZUMASA MIKAMI, Yokohama (JP)

(73) Assignee: Fujitsu Limited, Kawasaki-shi (JP)

(21) Appl. No.: 19/335,295

(22) Filed: Sep. 22, 2025

Related U.S. Application Data
(63) Continuation of application No. PCT/JP2024/006249, filed on Feb. 21, 2024.

(30) Foreign Application Priority Data
Mar. 23, 2023 (JP) 2023-046716
Nov. 9, 2023 (JP) 2023-191514

(51) Int. Cl. H04B 10/27; H04L 5/00

(52) U.S. Cl. CPC H04B 10/27; H04L 5/0048

(57) ABSTRACT

An optical transmission device includes a first processing circuit that deletes, from a plurality of packets, a specific data which does not affect normal transmission and reception of an optical signal obtained by converting a first transmission frame before mapping the plurality of packets into the first transmission frame, a second processing circuit that maps the plurality of packets into the first transmission frame without using a multiplex hierarchy after removing a padding data stored between the plurality of packets and pre-padding an empty data area by a removal of the padding data with the plurality of packets in order, and a third processing circuit that converts the first transmission frame in which the plurality of packets are mapped into the optical signal and transmits the optical signal.

### CROSS-REFERENCE TO RELATED APPLICATION

This application is a continuation application of International Patent Application No. PCT/JP2024/006249, filed on Feb. 21, 2024, which claims priority to Japanese Patent Application No. 2023-046716 filed on Mar. 23, 2023 and Japanese Patent Application No. 2023-191514, filed on Nov. 9, 2023, subject matter of these documents is incorporated.

### FIELD

A certain aspect of embodiments described herein relates to an optical transmission device and an optical transmission method.

### BACKGROUND

An optical transmission network is known (see, for example, Japanese Patent Application Publication No. 2018-519699). A technique for mapping a client signal of 100 Gbps into a transmission frame for optical transmission of 100 Gbps is known. As a transmission frame, for example, an optical channel transport unit 4 (OTU4) frame (112 Gbps) is known (see, for example, Japanese Patent Application Publication No. 2016-046593).

### SUMMARY

According to an aspect of the embodiments, there is provided an optical transmission device includes a first processing circuit that deletes, from a plurality of packets, a specific data which does not affect normal transmission and reception of an optical signal obtained by converting a first transmission frame before mapping the plurality of packets into the first transmission frame, a second processing circuit that maps the plurality of packets into the first transmission frame without using a multiplex hierarchy after removing a padding data stored between the plurality of packets and pre-padding an empty data area by a removal of the padding data with the plurality of packets in order, and a third processing circuit that converts the first transmission frame in which the plurality of packets are mapped into the optical signal and transmits the optical signal.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is an example of an optical transmission system.

FIG. 2A is a diagram for explaining an example of a direct mapping according to the first embodiment.

FIG. 2B is a diagram for explaining an example of a multiplex hierarchy.

FIG. 3A is a block diagram illustrating an example of a hardware configuration of an optical transmission device.

FIG. 3B is a block diagram illustrating an example of a functional configuration of the optical transmission device.

FIG. 4 is a block diagram illustrating an example of a functional configuration of a transmitter according to the first embodiment.

FIG. 5A is an example of a format of a PCIe TLP.

FIG. 5B is an example of a format of a header area in the PCIe TLP.

FIG. 6 is a diagram for explaining an example of processing executed by a framer.

FIG. 7A is an example of a format of an OTN frame and a format of an overhead.

FIG. 7B is an example of a detailed format of the overhead.

FIG. 8 is a flowchart illustrating an example of an operation at the time of transmission of the optical transmission device according to the first embodiment.

FIG. 9 is a flowchart illustrating an example of a mapping processing.

FIG. 10 is a diagram for explaining an example of a processing executed by the framer according to the first embodiment.

FIG. 11 is a flowchart illustrating an example of an operation at the time of reception of the optical transmission device according to the first embodiment.

FIG. 12 is a flowchart illustrating an example of an extraction processing.

FIG. 13 is a diagram for explaining an example of a processing executed by a deframer.

FIG. 14 is a diagram for explaining another example of a processing executed by the deframer.

FIG. 15 is a diagram for explaining an example of a processing executed by the deframer when an abnormality occurs.

FIG. 16 is a diagram for explaining an example of a direct mapping according to a second embodiment.

FIG. 17 is a block diagram illustrating an example of a functional configuration of a transmitter according to the second embodiment.

FIG. 18A is an example of a part of a format of a message area in a CXL packet.

FIG. 18B is an example of a rest of the format of the message area in the CXL packet.

FIG. 19A is a diagram for explaining an example of a processing of a responder.

FIG. 19B is an example of a log comparing table.

FIG. 20 is a flowchart illustrating an example of an operation at the time of transmission of the optical transmission device according to the second embodiment.

FIG. 21 is a diagram for explaining an example of a processing executed by the framer according to the second embodiment.

FIG. 22 is a flowchart illustrating an example of an operation at the time of reception of the optical transmission device according to the second embodiment.

FIG. 23 is a flowchart illustrating an example of an operation at the time of transfer of another optical transmission device according to the second embodiment.

FIG. 24 is a flowchart illustrating an example of the operation at the time of comparation of the optical transmission device according to the second embodiment.

### DESCRIPTION OF EMBODIMENTS

There are cases where a plurality of servers are installed in one data center and data communication is performed between the servers. Data communication may also be performed between servers installed in different data centers. When the data communication is performed between servers, a processor of a server is used for the data communication. When an application software of the server is executed in a state where the processor is used for the data communication, a load of the processor increases.

For a purpose of reducing such increase in the load of the processor, a smart network interface card (NIC) has been attracting attention. The smart NIC has a processor and is used by attaching it to a PCIe slot in the server. The smart NIC extracts a transaction layer packet called a PCI express transaction layer packet (PCIe TLP) from a PCIe frame (or a PCIe physical packet) received as a client signal from the server. After extracting the packet, the smart NIC maps the packet into an Ethernet (registered trademark) frame and transmits the Ethernet frame. Since the smart NIC shares the processing related to the data communication separately from the server, the increase in the load of the processor of the server is reduced.

Furthermore, in order to achieve low latency and low power consumption in the data communication, it is assumed that the smart NIC is equipped with optical transmission functions. In this case, the smart NIC having optical transmission functions (hereinafter referred to as an optical transmission device) transmits an optical transmission network (OTN) frame to the OTN by mapping the Ethernet frame into the OTN frame. The OTN frame is also a transmission frame for the optical transmission, and includes, for example, a FlexO frame.

However, the mapping of the Ethernet frame into the OTN frame requires the multiplex hierarchy defined by International Telecommunication Union-Telecommunication Standardization Sector (ITU-T) recommendation G.709. A mapping efficiency is reduced in the multiplex hierarchy, and as a result, there is a possibility that a processing delay occurs in the data communication.

Hereinafter, a description will be given of embodiments of the present disclosure with reference to the accompanying drawings.

### First Embodiment

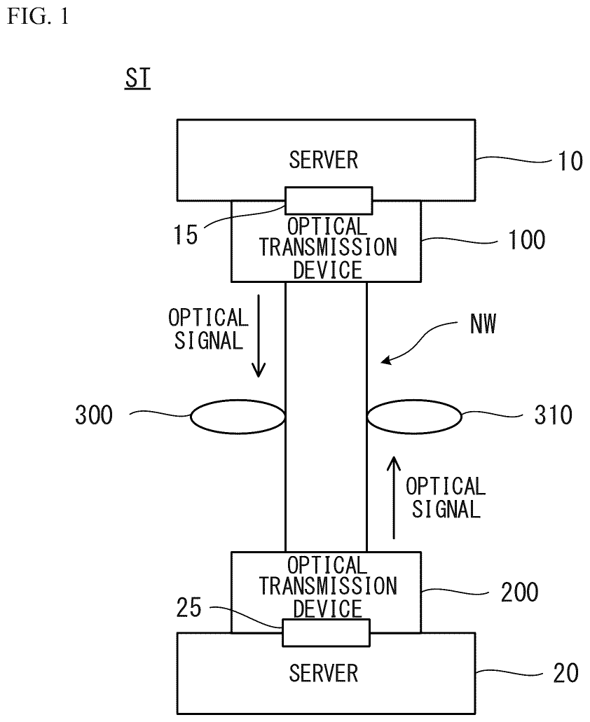

As illustrated in FIG. 1, the optical transmission system ST has optical transmission devices 100, 200. The optical transmission devices 100, 200 are connected to each other via an optical transmission lines 300, 310. The optical transmission lines 300, 310 include, for example, an optical fiber. The optical transmission lines 300, 310 are included in the optical transmission network NW.

The optical transmission device 100 is connected to a server 10 via a PCIe connector 15. The PCIe connector 15 includes a PCIe slot of the server 10 and a connector of the optical transmission device 100. The optical transmission device 200 is connected to a server 20 via a PCIe connector 25. The PCIe connector 25 includes a PCIe slot of the server 20 and a connector of the optical transmission device 200. When the connector is mounted in the PCIe slot, the optical transmission device 100 is connected to the server 10, and the optical transmission device 200 is connected to the server 20.

The optical transmission device 100 receives an electrical PCIe frame in a digital format as a client signal from the server 10. Since the PCIe frame is a packet of the physical layer, the PCIe frame may be referred to as a PCIe physical packet. The optical transmission device 100 converts the received PCIe frame into the transmission frame for the optical transmission.

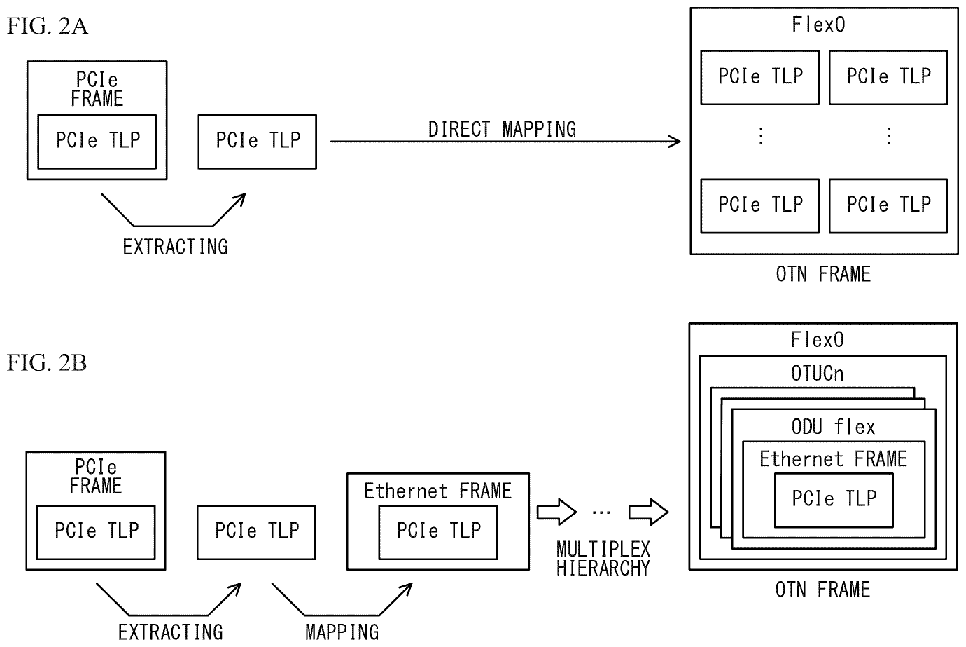

For example, as illustrated in FIG. 2A, the PCIe TLP is stored in the PCIe frame. The optical transmission device 100 extracts the PCIe TLP from the PCIe frame. When the PCIe TLP is extracted, the optical transmission device 100 directly maps the PCIe TLP into the OTN frame such as the FlexO frame. Such directly mapping is sometimes referred to as the direct mapping. When there is a margin in the OTN frame, the optical transmission device 100 maps the succeeding PCIe TLP into the OTN frame in order. Thus, a plurality of PCIe TLPs are mapped in the OTN frame.

Here, as illustrated in FIG. 2B, a case where the optical transmission device 100 maps the PCIe TLP extracted from the PCIe frame into the Ethernet (registered trademark) frame and maps the Ethernet (registered trademark) frame into the OTN frame by the multiplex hierarchy will be described. In this case, first, the optical transmission device 100 maps the Ethernet (registered trademark) frame in an ODUflex frame. Next, the optical transmission device 100 maps the ODUflex frame into the OTUCn frame. When there is a margin in the OTUCn frame, the optical transmission device 100 maps the subsequent ODUflex frames into the OTUCn frame in order. Thus, a plurality of ODUflex frames are mapped in the OTUCn frame. When a plurality of ODUflex frames are mapped into the OTUCn frame, the optical transmission device 100 maps the OTUCn frame into the OTN frame such as the FlexO frame.

When the OTN frame for the optical transmission is generated by using the multiplex hierarchy that multiplexes and maps a wide variety of frames, the processing is delayed due to the multiplex hierarchy. In the processing of the multiplex hierarchy, the PCIe TLP are mapped into various intermediate transmission frames having fixed lengths such as the Ethernet (registered trademark) frame, the ODUflex frame, and the OTUCn frame. Since the intermediate transmission frames compress the mapping area of the OTN frame such as the FlexO frame, the mapping amount of the PCIe TLP in the OTN frame is reduced as a result. That is, when the multiplex hierarchy is used, the mapping efficiency of the PCIe TLP is lowered and the processing delay is caused in the data communication.

However, according to the present embodiment, the PCIe TLP is directly mapped into the OTN frame. Since there are no intermediate transmission frames, a space is secured in the area of the OTN frame occupied by the intermediate transmission frames, and a large number of the PCIe TLP can be mapped. This makes it possible to suppress the lowering of the mapping efficiency of the PCIe TLP. Further, since the multiplex hierarchy is not used, it is possible to suppress the processing delay related to the data communication.

Referring back to FIG. 1, when the PCIe TLP is mapped into the OTN frame, the optical transmission device 100 generates a forward error correction (FEC) which is an error correction code, and adds the FEC to the OTN frame. When the FEC is added to the OTN frame, the optical transmission device 100 converts the OTN frame from the electric signal to the optical signal, and transmits the optical signal to the optical transmission device 200.

The optical transmission device 200 receives the optical signal transmitted from the optical transmission device 100 and passed through the optical transmission line 300. When the optical transmission device 200 receives the optical signal, the optical transmission device 200 converts the optical signal into an electrical OTN frame, extracts the FEC from the OTN frame, and performs error correction. After the error correction, the optical transmission device 200 extracts (demaps) the PCIe TLP from the OTN frame, maps the PCIe TLP into the PCIe frame, and transfers the PCIe frame to the server 20.

Although the optical transmission device 100 is described as an optical signal transmission side and the optical transmission device 200 is described as an optical signal reception side as an example, the optical transmission device 200 is also described as the optical signal transmission side and the optical transmission device 100 is described as the optical signal reception side, basically in the same manner as described above. In this case, the optical transmission device 100 receives the optical signal transmitted from the optical transmission device 200 and passed through the optical transmission line 310.

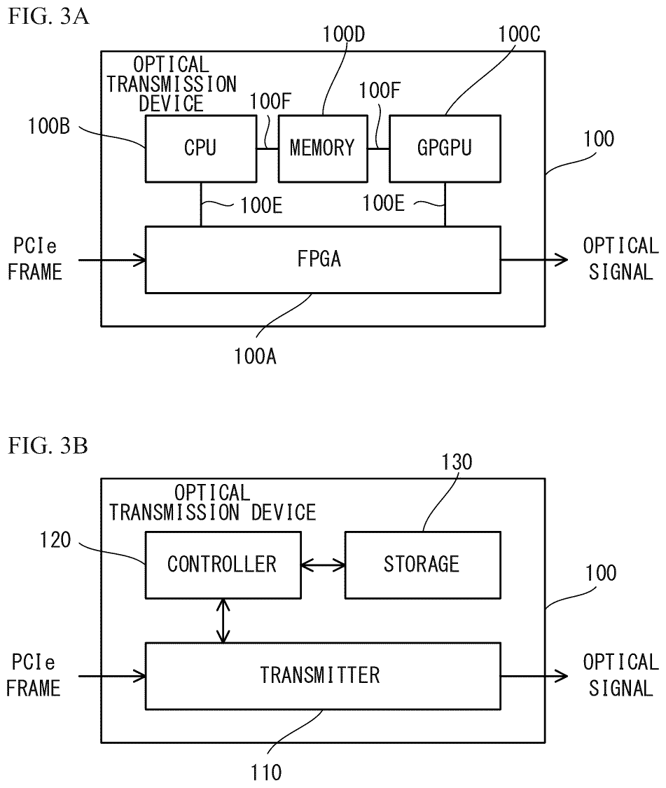

Referring to FIGS. 3A and 3B, the configuration of the optical transmission device 100 will be described in detail. The optical transmission device 200 has basically the same configuration as the optical transmission device 100, and therefore, a detailed description thereof will be omitted.

First, as illustrated in FIG. 3A, the optical transmission device 100 includes, as hardware circuits, a field programmable gate array (FPGA) 100A, a central processing unit (CPU) 100B, a general-purpose computing on graphic processing unit (GPGPU) 100C, and a memory 100D. Although not illustrated, an optical transceiver such as a quad small form-factor pluggable (QSFP) may be provided in the subsequent stage of the FPGA 100A. For example, the FPGA 100A executes a processing of an optical transmission layer, and the GPGPU 100C executes a processing of an internet protocol (IP) layer. The CPU 100B controls an entire processing of the optical transmission device 100.

Instead of the FPGA 100A, a hardware circuit such as a digital signal processor (DSP), an application specific integrated circuit (ASIC), or a large-scale integration (LSI) may be adopted. The memory 100D includes either or both of a random-access memory (RAM) and a read only memory (ROM). The RAM may be, for example, a double-data-rate synchronous dynamic random-access memory (DDR).

The FPGA 100A is connected to the CPU 100B and the GPGPU 100C by an internal bus 100E. The CPU 100B and the GPGPU 100C are connected to the memory 100D through an internal bus 100F. The FPGA 100A realizes the functions described later and executes various processes according to the flowcharts described later. For example, the FPGA 100A realizes functions and executes processing by programs stored therein.

Next, as illustrated in FIG. 3B, the optical transmission device 100 includes a transmitter 110, a controller 120, and a storage 130. The transmitter 110 can be realized by the FPGA 100A, the optical transceiver, or the like. The controller 120 can be realized by the CPU 100B and the GPGPU 100C described above. The storage 130 can be realized by the memory 100D described above. Therefore, the transmitter 110 is connected to the controller 120, and the controller 120 is connected to the storage 130.

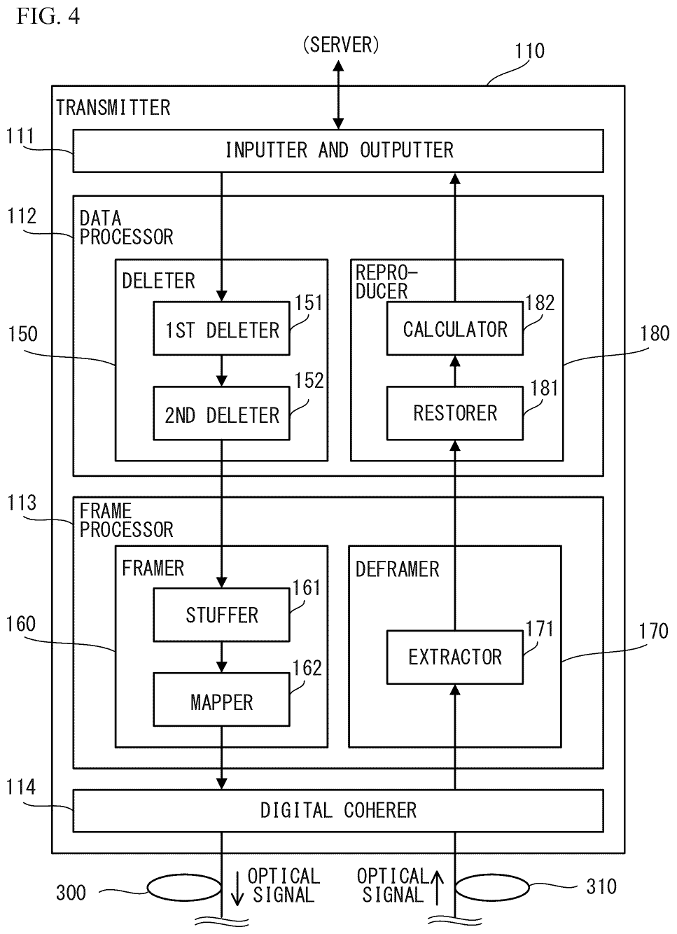

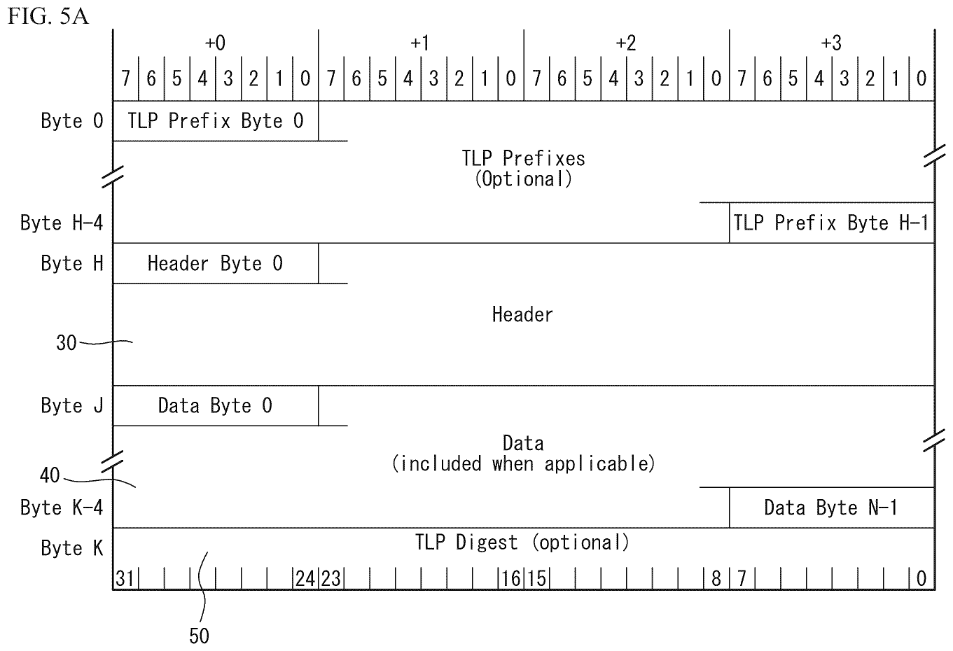

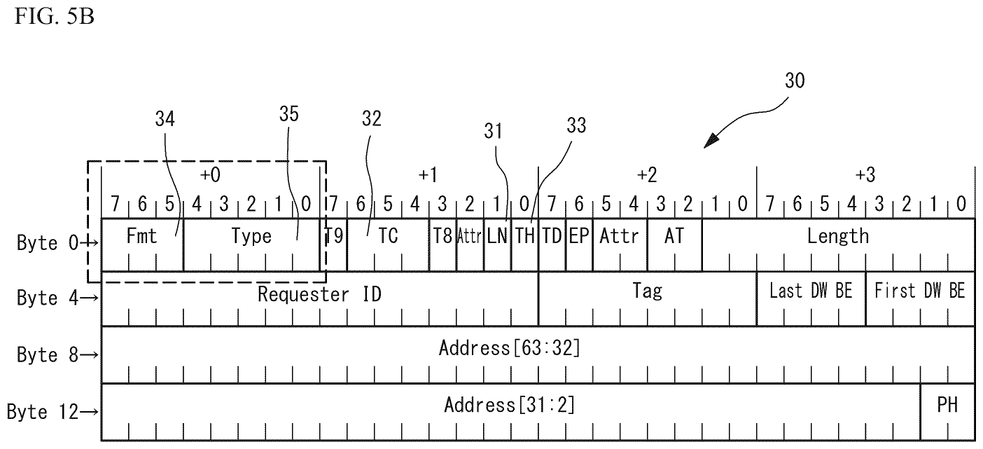

Referring to FIGS. 4 to 7B, the transmitter 110 will be described in detail.

As illustrated in FIG. 4, the transmitter 110 includes an inputter and outputter 111, a data processor 112, a frame processor 113, and a digital coherer 114. The data processor 112 is an example of a first processing circuit. The frame processor 113 is an example of a second processing circuit. The digital coherer 114 is an example of a third processing circuit.

The data processor 112 includes a deleter 150 and a reproducer 180. The deleter 150 includes a first deleter 151 and a second deleter 152, and the reproducer 180 includes a restorer 181 and a calculator 182. On the other hand, the frame processor 113 includes a framer 160 and a deframer 170. The framer 160 includes a stuffer 161 and a mapper 162, and the deframer 170 includes an extractor 171.

The PCIe frame output from the server 10 is sequentially and continuously input to the inputter and outputter 111. When the PCIe frame is input to the inputter and outputter 111, the inputter and outputter 111 extracts the PCIe TLP mapped in the PCIe frame (see FIG. 2A) and sequentially outputs the extracted PCIe TLP to the first deleter 151. The PCIe TLP output from the calculator 182 is input to the inputter and outputter 111. When the PCIe TLP is input to the inputter and outputter 111, the inputter and outputter 111 maps the PCIe TLP into the PCIe frame and outputs the PCIe frame to the server 10.

The first deleter 151 deletes a cyclic redundancy check (CRC) data added to the PCIe TLP from the PCIe TLP output from the inputter and outputter 111. The CRC data is an example of a specific data that does not affect normal transmission and reception of the optical signal obtained by converting the OTN frame. As described above, since the FEC is added to the OTN frame, it is assumed that the CRC data added to the PCIe TLP is not affected or is not so much affected by the normal transmission and reception of the optical signal even if it is deleted. The first deleter 151 outputs the PCIe TLP from which the CRC is deleted to the second deleter 152.

The second deleter 152 deletes a length data, which is a part of a header field, from the header field of the PCIe TLP output from the first deleter 151. The length data is also an example of the specific data that does not affect normal transmission and reception of an optical signal obtained by converting the OTN frame. For example, there is a case where the PCIe TLP does not include a main data corresponding to a main signal. In this case, since there is no data length of the main data, the length data is unnecessary. Therefore, if the optical transmission devices 100, 200 that are opposed to each other agree that the length data is to be deleted, it is assumed that the deletion of the length data does not affect or slightly affects the normal transmission and reception of the optical signal. When the second deleter 152 deletes the length data, the second deleter 152 outputs the PCIe TLP from which the length data is deleted to the stuffer 161.

In the PCIe TLP, as illustrated in FIG. 5A, a format including a header area 30, a date area 40, an option area 50, and the like is defined in advance. The CRC data described above is stored in the option area 50, and the main data is stored in the data area 40.

As illustrated in FIG. 5B, the format is also defined in advance in the header area 30, and the length data is stored in an LN area 31. Although the second deleter 152 deletes the length data as an example, the data stored in a TC area 32 and the data stored in a TH area 33 may be deleted if the influence on the normal transmission and reception of the optical signal is slight.

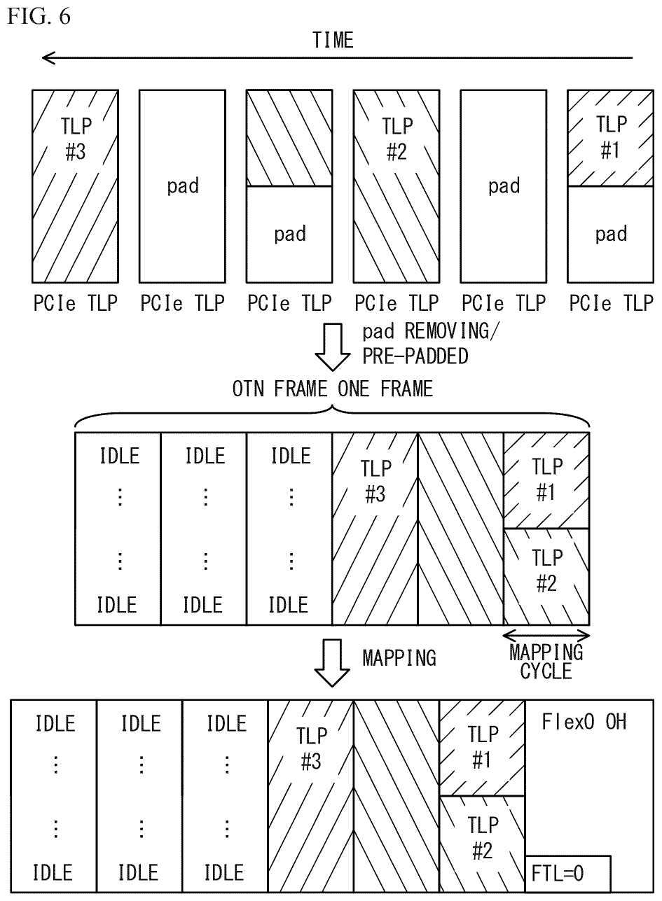

The stuffer 161 receives the PCIe TLP output from the second deleter 152. As illustrated in an upper part of FIG. 6, the PCIe TLP is sequentially and continuously input to the stuffer 161. Since the PCIe TLP is a variable-length packet, there is a case where the packet size of the PCIe TLP is smaller than a predetermined packet size (or packet length) depending on a data amount of the main data of the PCIe TLP. In this case, the padding data (indicated by “pad” in FIG. 6) is stuffed in a residual area of the packet size of the PCIe TLP, and the packet size is adjusted to the predetermined packet size (see TLP #1).

On the other hand, there is a case where the packet size is larger than the predetermined packet size depending on the data amount of the main data of the PCIe TLP. In this case, the main data of the PCIe TLP is divided, and for example, the second half of the main data is stored in the next PCIe TLP (see TLP #2). The stuffer 161 removes the padding data as illustrated in a middle part of FIG. 6 every time the stuffer 161 receives the PCIe TLP and detects the padding data. The data area is made free by removing the padding data. Therefore, as illustrated in the middle part of FIG. 6, the header data and the main data stored in the header area of the PCIe TLP are pre-padded as TLP data (TLP #1, TLP #2, etc.).

Here, even if the TLP data is pre-padded, there is a case where it is not be enough for one frame of the OTN frame. In this case, the stuffer 161 inserts an IDLE pattern into the residual data area remaining in the OTN frame and fills the residual data area with the IDLE pattern. The IDLE pattern is an example of data to be discarded, and is discarded by the optical transmission device 200. As illustrated in FIG. 5B, an Fmt area 34 and a Type area 35 are defined in a first 1 byte of the header area 30.

The stuffer 161 inserts a bit string not defined in the PCIe standard into the Fmt area 34 and the Type area 35 defined in the first byte as an IDLE pattern. For example, the stuffer 161 inserts the bit string “11100000” to make the optical transmission device 200 recognize that this data is unnecessary data. In this way, it is possible to determine whether or not the data is unnecessary on the optical signal reception side. The stuffer 161 holds a block of one frame in which the main data of the PCIe TLP is pre-paded.

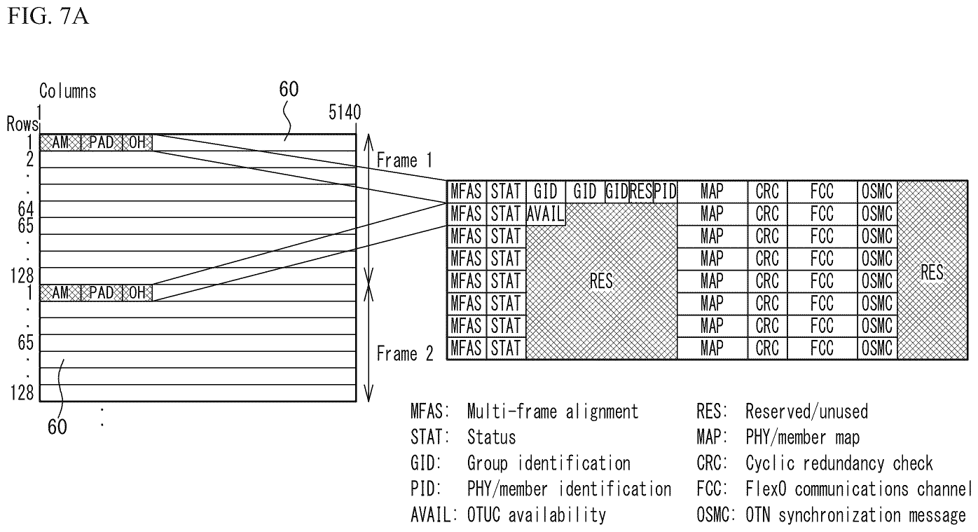

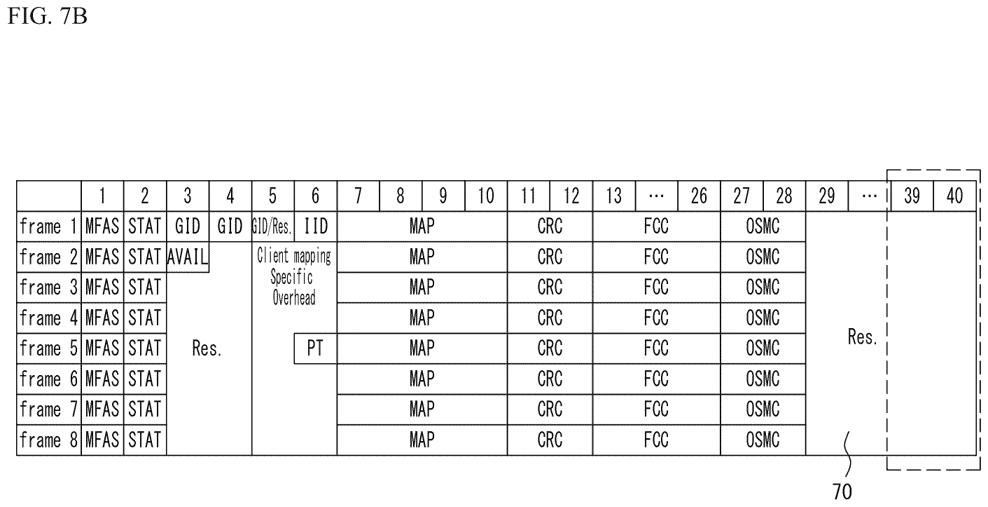

The mapper 162 acquires the TLP data for one mapping cycle from the data block held by the stuffer 161 and maps the TLP data into the OTN frame. For example, as illustrated in the lower part of FIG. 6 and FIG. 7A, the mapper 162 maps a data block in the payload portion 60 located behind the overhead of the OTN frame (abbreviated as OH in FIGS. 6 and 7A). The mapper 162 stores information indicating whether the TLP data positioned at the head of the OTN frame is a divided data or an undivided data in a designated area of the overhead of the OTN frame. The divided data indicates a data into which the TLP data is divided, and the undivided data indicates a data into which the TLP data is not divided.

For example, as illustrated in FIG. 7B, the mapper 162 stores information on the division by using the 39th byte and the 40th byte of a reserved area 70 of the overhead as designated areas. When the TLP data is the undivided data, the mapper 162 stores an identification value “0” (FTL=0) indicating that the TLP data is the undivided data, as illustrated in the lower part of FIG. 6. As will be described in detail later, when the TLP data is the divided data, the mapper 162 stores the number of bytes of the TLP data in the OTN frame. That is, the mapper 162 stores the number of bytes of the second half of the divided TLP data. The mapper 162 maps the data block into the OTN frame and outputs the OTN frame to the digital coherer 114. Thus, it can be determined whether or not the TLP data is the divided data, and if the TLP data is the divided data, the TLP data can be restored on the optical signal reception side.

The digital coherer 114 converts the OTN frame into the optical signal and transmits the optical signal to the optical transmission device 200. Although not illustrated, the digital coherer 114 includes an FEC encoder for adding the FEC to the OTN frame, a digital to analogue converter (DAC) for converting the OTN frame from the digital format to the analogue format, and the like. The digital coherer 114 includes an optical modulator for converting an analog OTN frame into the optical signal by a local oscillator and transmitting the optical signal, and a coherent receiver for converting the optical signal received from the optical transmission line 310 into the analog OTN frame by the local oscillator. In addition, the digital coherer 114 includes an analogue to digital converter (ADC) for converting the analog OTN frame into a digital OTN frame, an FEC decoder for performing error correction of the OTN frame based on the FEC added to the OTN frame and outputting the OTN frame to the extractor 171, and the like.

The extractor 171 extracts the TLP data from the OTN frame output from the digital coherer 114 and outputs the TLP data to the restorer 181. The length data, the CRC data, and the like are deleted by the optical transmission device 200 in the TLP data extracted by the extractor 171. Therefore, the restorer 181 restores the header data stored in the header, such as the length data, based on the prior agreement with the optical transmission device 100, and outputs the head data to the calculator 182. The calculator 182 recalculates the CRC based on the TLP data outputted from the restorer 181, adds the CRC to the TLP data, and reproduces the PCIe TLP. When the PCIe TLP is reproduced, the calculator 182 outputs the PCIe TLP to the inputter and outputter 111. Thus, the inputter and outputter 111 maps the PCIe TLP into the PCIe frame and outputs the PCIe frame to the server 10.

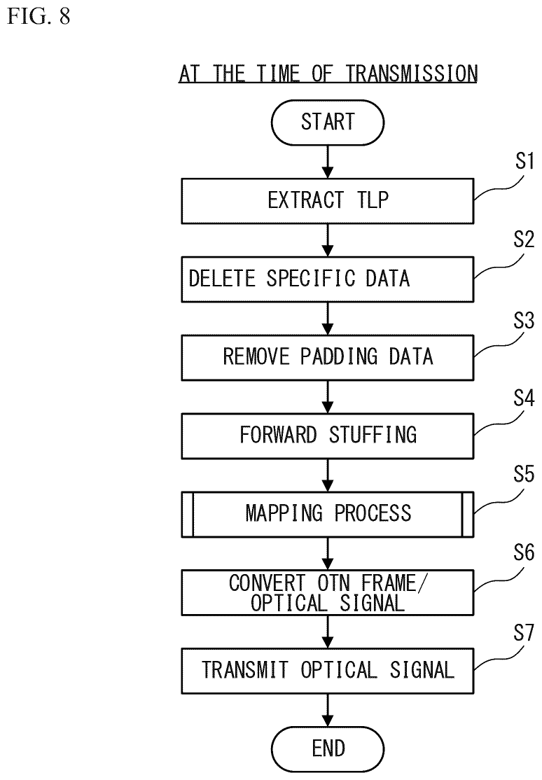

Referring to FIG. 8, the operation at the time of transmission of the optical transmission device 100 according to the first embodiment will be described.

First, the inputter and outputter 111 extracts the PCIe TLP from the PCIe frame (step S1). When the inputter and outputter 111 extracts the PCIe TLP, the deleter 150 deletes the specific data (step S2). More specifically, the first deleter 151 deletes the CRC data as an example of the specific data, and the second deleter 152 deletes the length data as an example of the specific data.

When the deleter 150 deletes the specific data, the stuffer 161 removes the padding data from the PCIe TLP (step S3) and executes forward stuffing of the TPL data (step S4). That is, the stuffer 161 removes the padding data every time the padding data is detected, and pre-pads the TLP data (see the middle part of FIG. 6). When the stuffer 161 executes the forward stuffing, the mapper 162 executes the mapping processing (step S5). The mapping processing is a processing for acquiring the TLP data for the mapping period from the data block for one frame and mapping the TLP data into the OTN frame. The details of the mapping processing will be described later.

When the mapper 162 completes the mapping processing, the digital coherer 114 converts the OTN frame into the optical signal (step S6) and transmits the optical signal (step S7). When the optical signal is transmitted, the optical transmission device 100 ends the operation at the time of transmission. Thus, the optical signal is transmitted from the optical transmission device 100, and the optical transmission device 200 receives the optical signal.

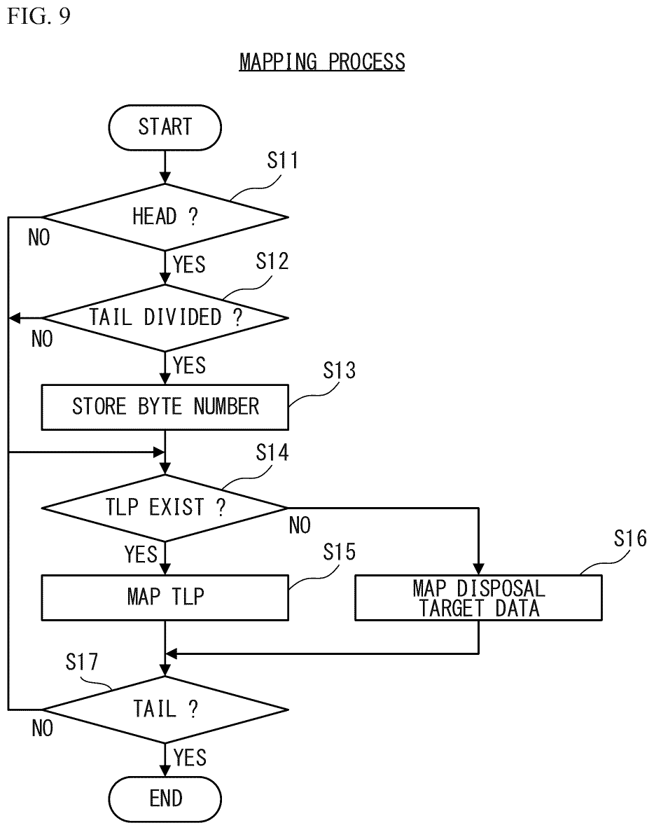

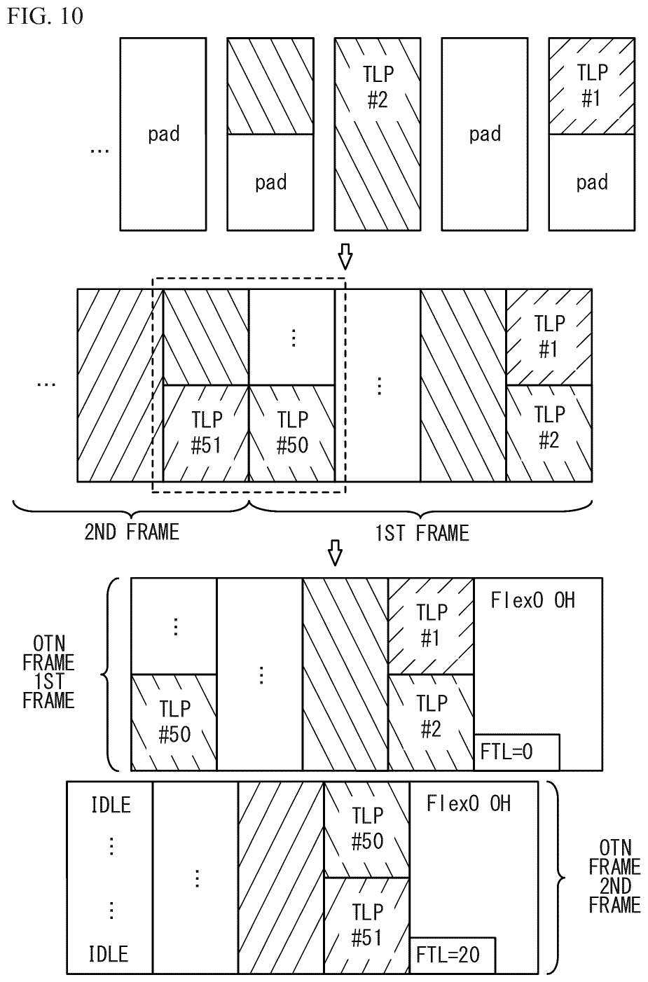

Referring to FIGS. 9 and 10 the details of the above mapping processing will be described.

First, as illustrated in FIG. 9, the mapper 162 determines whether or not the mapping destination is a data area located at the head of the OTN frame (step S11). If the mapping destination is the data area at the head of the OTN frame (step S11: YES), the mapper 162 determines whether or not the mapper 162 has divided the TLP data at the tail end of the immediately preceding OTN frame (step S12). When the TLP data at the end of the immediately preceding OTN frame has divided (step S12: YES), the mapper 162 stores the number of bytes in a designated area of the overhead of the OTN frame (step S13).

For example, as illustrated in the upper and middle portions of FIG. 10, when the OTN frame of a second frame is a frame to be processed by the mapping processing, the TLP data at the tail end (TLP #50) of a first frame immediately before the OTN frame of the second frame is divided by the mapper 162. When the TLP data at the tail end of the immediately preceding OTN frame is divided in this way, the mapper 162 stores the number of bytes “20” (FTL=20) in the designated area of the overhead of the second OTN frame, as illustrated in the lower part of FIG. 10.

Thus, the optical transmission device 200 can determine that the TLP data mapped in the data area at the head of the second OTN frame is the divided data after receiving the optical signal. If the mapping destination is not the data area located at the head of the OTN frame (step S11: NO) or if the TLP data at the tail end of the immediately preceding OTN frame is not divided (step S12: NO), the mapper 162 skips the processing of step S13.

When any of the processing of steps S11 to S13 is completed, the mapper 162 determines whether or not the TLP data exists in the stuffer 161 located in the preceding stage of the mapper 162 (step S14). When the TLP data exists (step S14: YES), the mapper 162 maps the TLP data (step S15). More specifically, the mapper 162 acquires the TLP data for the mapping period (see FIG. 6) of the mapper 162 from the stuffer 161 and maps the TLP data into a target data area of the OTN frame. On the other hand, when the TLP data does not exist (step S14: NO), the mapper 162 maps the discard target data (step S16). That is, the mapper 162 inserts the IDLE pattern into the target data area of the OTN frame.

When the processing of step S15 or S16 is completed, the mapper 162 determines whether or not the mapping destination is the data area located at the tail end of the OTN frame (step S17). When the mapping destination is not the data area located at the tail end of the OTN frame (step S17: NO), the mapper 162 repeats the processing from step S14 to step S16. As a result, as long as the TLP data exists in the stuffer 161, the TLP data is mapped into the OTN frame one after another. When the stuffer 161 has no more TLP data, the discard target data is mapped up into the data area located at the tail end of the OTN frame.

As a result, as illustrated in the lower part of FIG. 10, for example, the discard target data is mapped into the second OTN frame. If the mapping destination is the data area located at the tail end of the OTN frame (step S17: YES), the mapper 162 ends the mapping processing. Thus, the mapper 162 outputs the OTN frame to the digital coherer 114 in the subsequent stage.

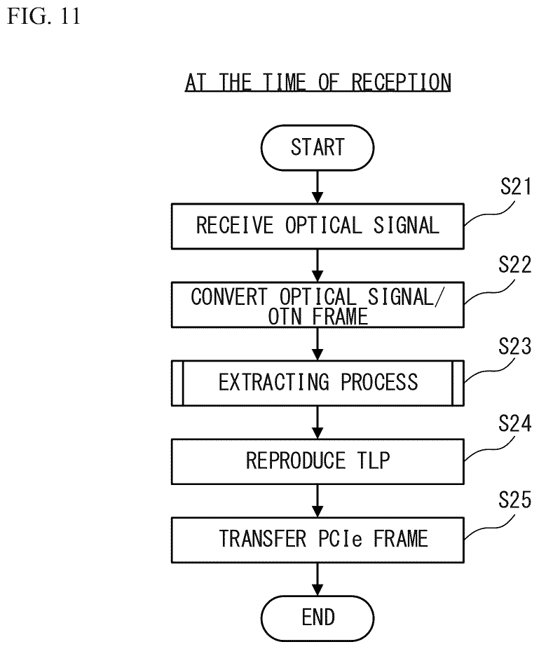

Referring to FIG. 11, the operation of the optical transmission device 100 at the time of reception will be described.

First, the digital coherer 114 receives the optical signal transmitted from the optical transmission device 200 (step S21). Upon receiving the optical signal, the digital coherer 114 converts the optical signal into the OTN frame (step S22). When the digital coherer 114 converts the optical signal into an OTN frame, the extractor 171 executes an extraction processing (step S23). The extraction processing is a processing of extracting the TLP data from the OTN frame. The details of the extraction processing will be described later.

When the extractor 171 has finished the extracting processing, the reproducer 180 reproduces the PCIe TLP (step S24). More specifically, the restorer 181 restores the length data and the like based on the data length of the TLP data, and the calculator 182 recalculates the CRC based on the TLP data including the length data and the like, and adds the CRC data to the TLP data. When the data size of the TLP data to which the CRC data is added is smaller than the predetermined packet size, the calculator 182 adds the padding data to the TLP data to satisfy the predetermined packet size.

When the reproducer 180 reproduces the PCIe TLP, the inputter and outputter 111 transfers the PCIe frame (step S25) and ends the operation. More specifically, the inputter and outputter 111 maps the PCIe TLP into the PCIe frame and transfers the PCIe frame to the server 10. In this way, the server 10 receives the PCIe frame transmitted from the server 20.

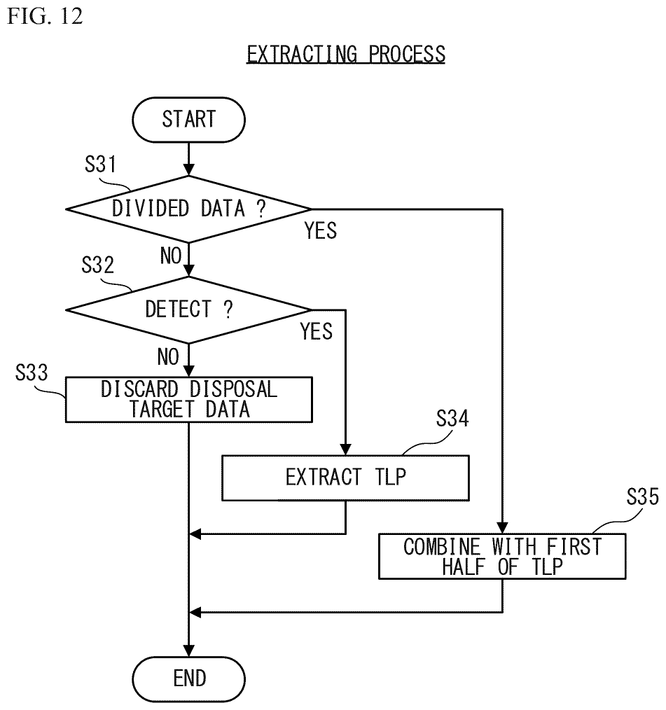

Refereeing to FIGS. 12 to 14, the details of the above-described extraction processing will be described. The extractor 171 extracts the TLP data at the same extraction cycle as the mapping cycle.

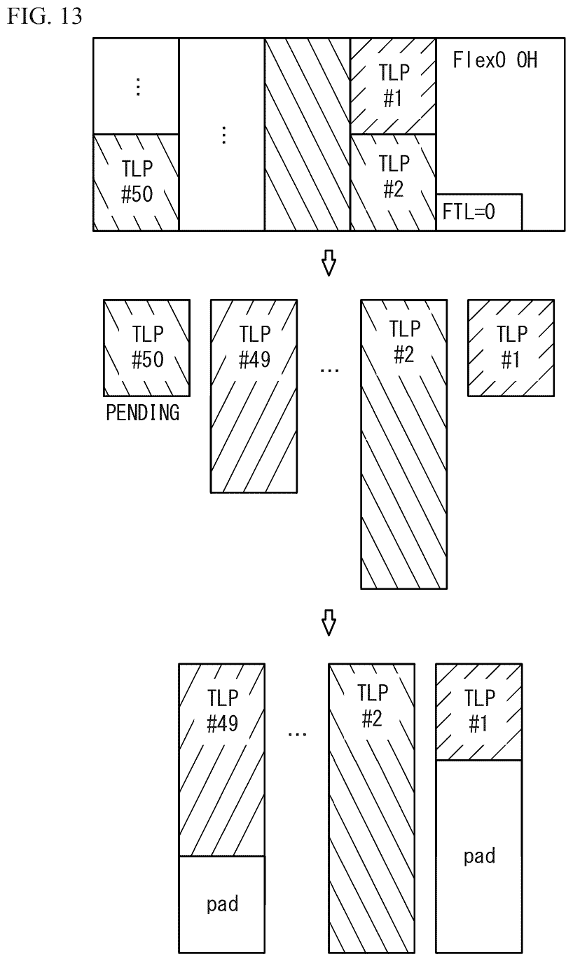

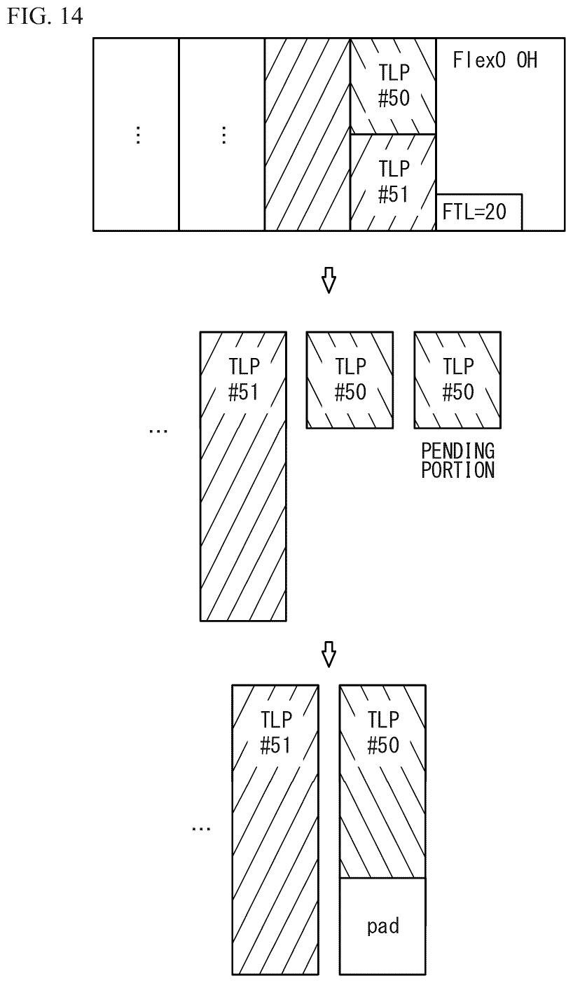

First, as illustrated in FIG. 12, the extractor 171 determines whether or not the data is the divided data (step S31). More specifically, the extractor 171 determines whether or not the TLP data stored in the data area located at the head of the OTN frame is the divided data based on the information stored in the designated area of the overhead of the OTN frame. For example, as illustrated in the upper part of FIG. 13, when the identification value “0” (FTL=0) is stored in the designated area of the overhead of the OTN frame, the extractor 171 determines that the TLP data stored in the data area located at the head of the OTN frame is the undivided data. On the other hand, as illustrated in the upper part of FIG. 14, when the number of bytes “20” (FTL=20) is stored in the designation area of the overhead of the OTN frame, the extractor 171 determines that the TLP data stored in the data area located at the head of the OTN frame is the divided data.

When the TLP data is the undivided data (step S31: NO), the extractor 171 determines whether or not the discard target data is detected (step S32). That is, the extractor 171 determines whether or not the IDLE pattern is detected. When the discard target data is detected (step S32: YES), the extractor 171 discards the discard target data (step S33), and ends the extraction processing. On the other hand, when no discard target data is detected (step S32: NO), the extractor 171 extracts the TLP data (step S34), and ends the extraction processing.

For example, as illustrated in the upper and middle parts of FIG. 13, the extractor 171 extracts the TLP data based on the length data of the TLP data stored in the header area of the TLP data. The extractor 171 repeats the extraction processing at each extracting cycle, and thus, for example, each of the TLP data from TLP #1 to TLP #49 is extracted. As illustrated in the lower part of FIG. 13, each of the TLP data is subjected to the restoration of the length data and the recalculation of the CRC, and then padded as necessary by the inputter and outputter 111, and is mapped into the PCIe TLP frame and output to the server 10.

On the other hand, when an actual packet length of the TLP data is different from the length data stored in the header area of the TLP data, the extractor 171 suspends the output of the TLP data to the subsequent stage. Thus, as illustrated in the upper and middle parts of FIG. 13, for example, if the TLP #50 is divided, the extractor 171 suspends the output to the subsequent stage of the TLP #50.

If the TLP data is the divided data in step S31 (step S31: YES), the extractor 171 combines the TLP data with the first half of the TLP data (step S35), and ends the extraction processing. For example, as illustrated in the upper and middle parts of FIG. 14, when the second half of the TLP data is stored in the data area located at the head of the OTN frame, the extractor 171 holds the first half of the TLP data stored in the data area located at the tail end of the OTN frame immediately before this OTN frame as the reserved portion. Therefore, the extractor 171 acquires the TLP data of 20 bytes from the data area located at the head of the OTN frame as the second half of the TLP data, combines the second half of the TLP data and the first half of the TLP data, and transmits the combined TLP data.

If the length data stored in the header area of the first half of the TLP data is the same as the combined TLP data, the extractor 171 determines that the combined TLP data has been extracted normally and outputs the combined TLP data to the subsequent stage. The extractor 171 extracts the residual TLP data following the second half of the TLP data by the same processing as that in the case where the TLP data is the undivided data. As illustrated in the lower part of FIG. 14, the TLP data is subjected to the restoration of the length and the recalculation of the CRC, and then the padding data is added as necessary in the inputter and outputter 111, and is mapped into the PCIe TLP frame and output to the server 10.

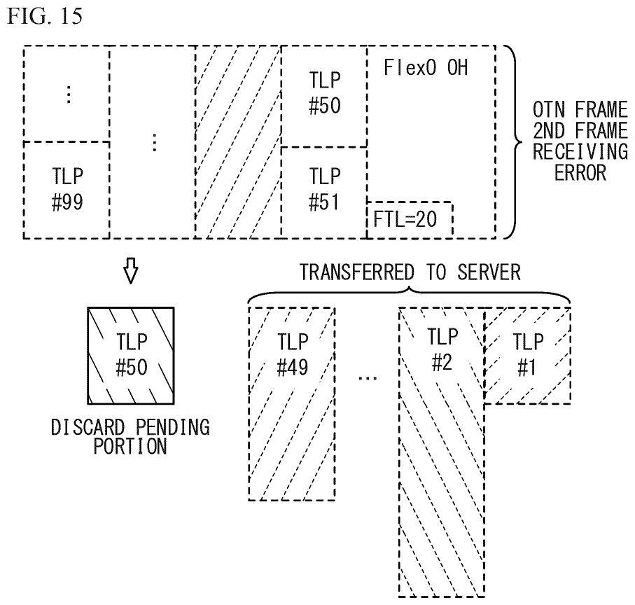

Although the extractor 171 normally receives the first frame of the OTN frame, as illustrated in FIG. 15, the extractor 171 may not normally receive the second frame of the OTN frame, for example, and a reception error may occur. In this case, the extractor 171 may discard the reserved portion of the TLP data. When the extractor 171 receives the third frame of the OTN frame after the reception error occurs in the second frame of the OTN frame, the second half of the TLP data may be stored in the data area located at the head of the OTN frame.

Since the first half of the TLP data is stored at the tail end of the second frame of the OTN frame, the second half of the TLP data cannot be reproduced when a reception error occurs. Therefore, in such a case, even if the extractor 171 extracts the second half of the TLP data stored in the data area located at the head of the OTN frame, the extractor 171 may discard the second half of the extracted TLP data. In this way, since the first half of the TLP data and the second half of the TLP data are discarded, it is possible to avoid that a part of the TLP data remains in the extractor 171.

As described above, the optical transmission device 100 according to the present embodiment includes the data processor 112, the frame processor 113, and the digital coherer 114. Before the plurality of the PCIe TLP are directly mapped into the OTN frame, the data processor 112 deletes, from the plurality of the PCIe TLP, the specific data which does not affect normal transmission and reception of the optical signal obtained by converting the OTN frame. The frame processor 113 removes the plurality of the padding data stored between the plurality of the PCIe TLP, pre-pads the empty space by the removal of the padding data with the plurality of the PCIe TLP in order, and then directly maps the plurality of the PCIe TLP in the OTN transmission frame without using the multiplex hierarchy. The digital coherer 114 converts the OTN frame mapping the plurality of the PCIe TLP into the optical signal and transmits the optical signal. This makes it possible to suppress a decrease in mapping efficiency when the PCIe TLP is mapped into the OTN frame.

### Second Embodiment

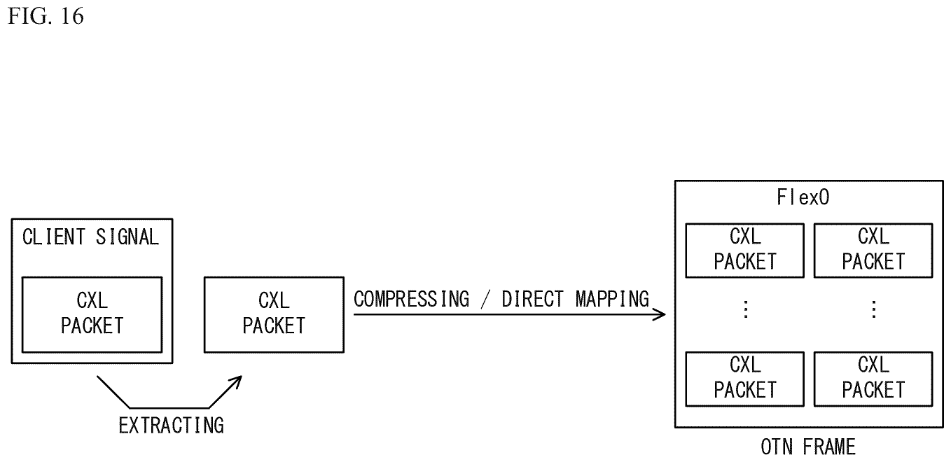

Refereeing to FIGS. 16 to 24, a second embodiment of the present matter will be described. First, as illustrated in FIG. 16, an electrical client signal in which a compute express link (CXL) packet is stored may be input to the optical transmission device 100. The CXL packet is an example of the specific packet and corresponds to MemWr of Master to Subordinate Request with Data (M2S RwD). Although the details will be described later, the CXL packet includes a packet of a transaction layer corresponding to the CXL.mem protocol as CXL information.

The optical transmission device 100 extracts the CXL packet from an input client signal. When the CXL packet is extracted, the optical transmission device 100 compresses the CXL packet, and directly maps a compressed CXL packet into the OTN frame, as in the first embodiment. The compressed CXL packet is an example of a compressed packet. When there is a margin in the OTN frame, the optical transmission device 100 sequentially maps a part or all of a subsequent CXL packet into the OTN frame. Thus, the OTN frame contains a plurality of compressed CXL packets.

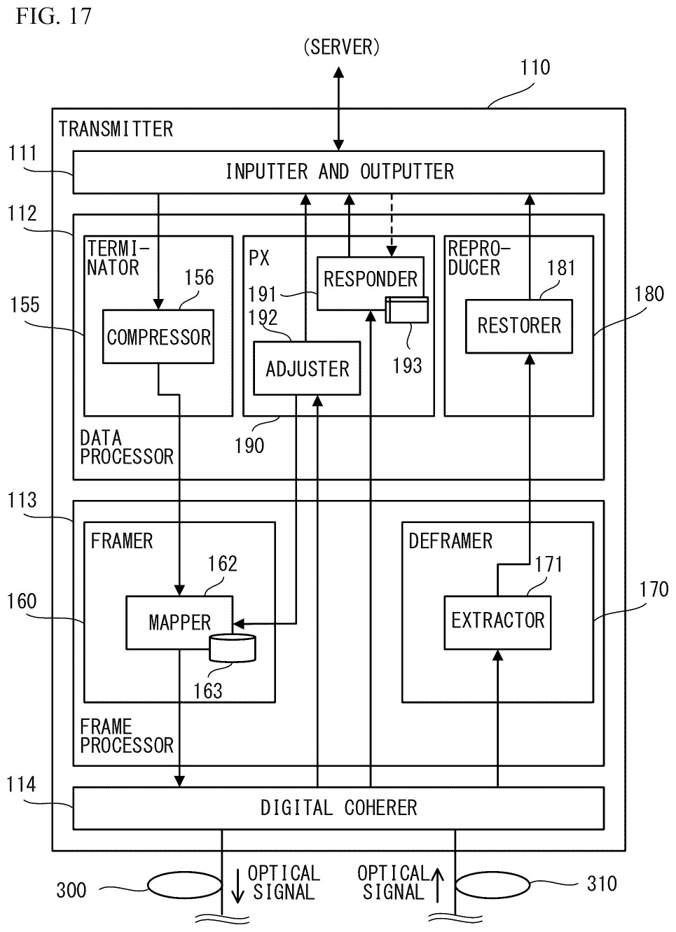

As illustrated in FIG. 17, the transmitter 110 according to the second embodiment includes the inputter and outputter 111, the data processor 112, the frame processor 113, and the digital coherer 114, as in the transmitter 110 according to the first embodiment. In FIG. 17, the same components as those illustrated in FIG. 4 are basically denoted by the same reference numerals, and detailed description thereof will be omitted.

The data processor 112 according to the second embodiment includes a terminator 155 instead of the deleter 150 described in the first embodiment. The data processor 112 according to the second embodiment differs from the data processor 112 according to the first embodiment in that it further includes a proxer (abbreviated as PX in FIG. 17) 190. In this way, the data processor 112 according to the second embodiment is different from the data processor 112 according to the first embodiment. The reproducer 180 may include the calculator 182 described in the first embodiment.

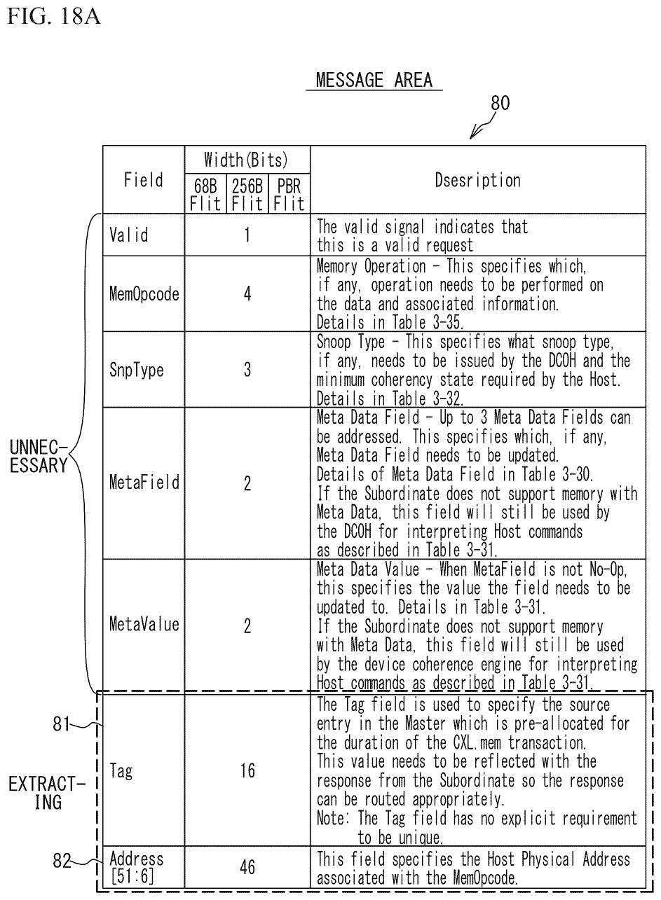

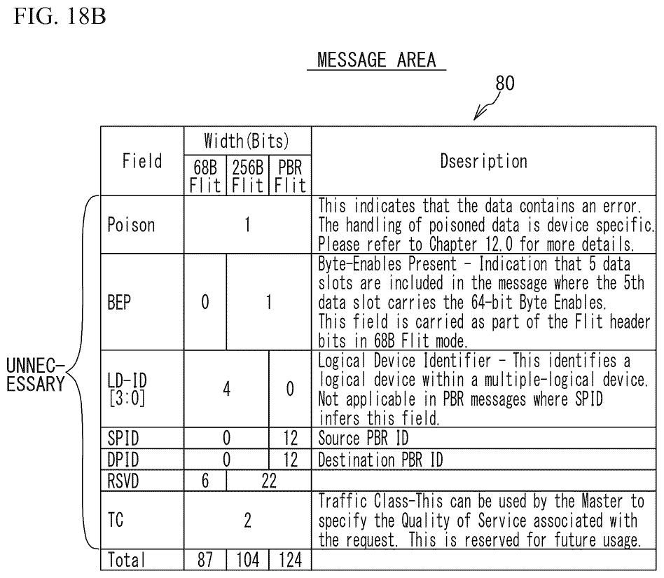

The terminator 155 includes a compressor 156. The compressor 156 compresses the CXL packet and generates the compressed packet obtained by compressing the CXL packet. More specifically, as illustrated in FIGS. 18A and 18B, the compressor 156 extracts a part of a message data stored in a message area 80 of the CXL packet. The message area 80 of the CXL packet corresponds to the header area 30 of the PCIe TLP. For example, the compressor 156 extracts a 16-bit tag data stored in a tag area 81 in the message area 80. The tag data can uniquely identify the CXL packet. The compressor 156 extracts a 46-bit address data stored in an address area 82 of the message area 80.

The compressor 156 extracts the tag data and the address data, and generates the compressed packet having the extracted tag data, address data, and a predetermined delimiter represented by two bits as a new message data. The new message data is 64 bits (8 bytes). The predetermined delimiter is a data for IDLE pattern identification. The compressed packet contains a write target data stored in the data area (not illustrated) of the CXL packet as it is. The write target data is a data to be written in a memory provided in the server 20 as a connection device or connected to the server 20, for example.

In this way, the compressor 156 can compress the CXL packet by generating the compressed packet limited to the tag data, the address data, the predetermined delimiter, and the write target data. That is, the terminator 155 terminates the residual message data stored in the message area 80 of the CXL packet as an unnecessary data which is not required on the server 20 side. The unnecessary data is an example of a non-write destination address. Since the CXL packet is compressed, more write target data can be mapped into one OTN frame.

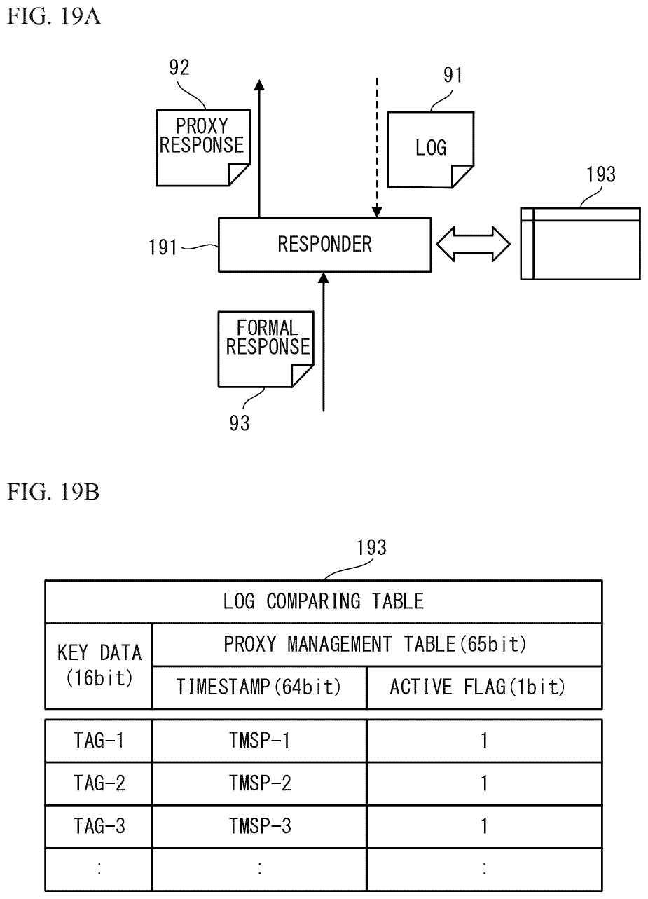

Referring back to FIG. 17, the proxer 190 includes a responder 191 and an adjuster 192. The responder 191 is associated with a log comparing table 193. As illustrated in FIG. 19A, every time the responder 191 is notified of the reception of the CXL packet together with a log data 91 from the inputter and outputter 111, the responder 191 issues a proxy response 92 instead of a formal response 93 issued by the server 20 before receiving the formal response 93 and transmits the proxy response 92 to the server 10. The log data 91 includes the tag data of the CXL packet, a reception time stamp, and the like. For example, when the client signal is input to the inputter and outputter 111 from the server 10 and the inputter and outputter 111 extracts the CXL packet from the client signal, the inputter and outputter 111 notifies the responder 191 of the reception of the CXL packet together with the log data 91. Thus, the responder 191 transmits the proxy response 92 to the server 10. The formal response 93 corresponds to a completion (completion notification) of an Subordinate to Master Non-Data Response (S2M NDR) in the CXL.mem protocol.

When the log data 91 is notified, the responder 191 stores the log data 91 in the log comparing table 193. More specifically, as illustrated in FIG. 19B, the responder 191 stores the tag data included in the log data 91 in the item of the key data of the log comparing table 193. The responder 191 stores the reception date and time in the item of the time stamp belonging to a proxy management data of the log comparing table 193. The responder 191 stores a flag value in the item of the active flag belonging to the proxy management data of the log comparing table 193.

For example, the flag value “1” represents a state before the responder 191 receives the formal response 93. When the responder 191 receives the formal response 93, the responder 191 updates the flag value “1” to the flag value “0” or the flag value “NULL”. The formal response 93 includes the tag data and a predetermined identifier indicating whether or not an abnormality has occurred in a writing processing of the write target data. When the responder 191 determines that an abnormality has occurred in the writing processing based on the predetermined identifier included in the formal response 93, the responder 191 updates the flag value “1” having the common tag data to the flag value “NULL”. When the responder 191 determines that no abnormality has occurred in the writing processing based on the predetermined identifier included in the formal response 93, the responder 191 updates the flag value “1” to the flag value “0”. When the flag value “NULL” is stored in the item of the active flag belonging to the log comparing table 193, the responder 191 notifies the server 10 of an error in the processing for the CXL packet. Thus, for example, the server 10 can retransmit the CXL packet in which the writing processing has been abnormally occurred.

Referring back to FIG. 17, the adjuster 192 adjusts the flow rate of the OTN frame to be supplied from the optical transmission device 100 to the optical transmission device 200 based on the credit information transmitted from the optical transmission device 200. The credit information is an example of specific information and includes a state of a processing load such as a congestion state of the server 20. The OTN frame is temporarily stored in a buffer 163 until it is converted into the optical signal. When the adjuster 192 determines that the processing load of the server 20 is high based on the credit information, the adjuster 192 temporarily interrupts or stops the transmission of the OTN frame stored in the buffer 163. This makes it possible to adjust a transmission rate to a receivable rate of the server 20 as the opposite.

The adjuster 192 monitors a storage amount of the OTN frame stored in the buffer 163. The storage amount may include a storage ratio or a storage rate. The adjuster 192 determines whether the buffer 163 is near-full when the credit information including the processing load of the server 20 is received from the optical transmission device 200. The near-full indicates in a state which the storage amount of the OTN frame is equal to or greater than a threshold storage amount. When the adjuster 192 determines that the buffer 163 is near-full, the adjuster 192 notifies the server 10 of credit control for requesting adjustment of transmission of the CXL packet. Thus, the server 10 adjusts the transmission rate of the CXL packet. As a result, it is possible to avoid an overflow in which the OTN frame exceeds the storage limit of the buffer 163.

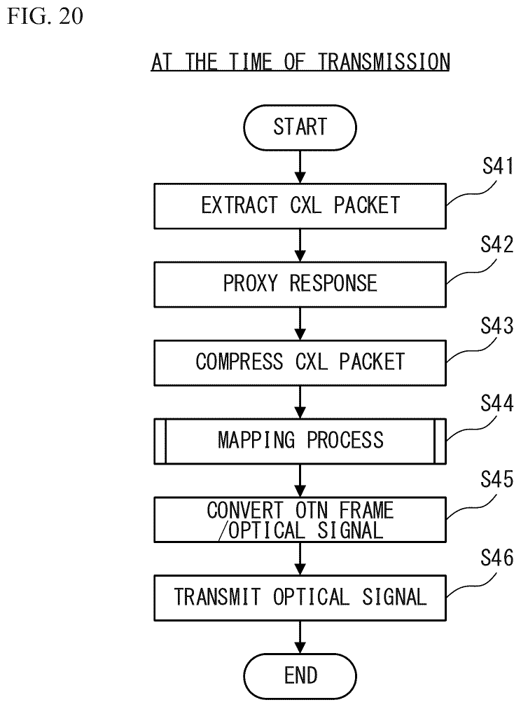

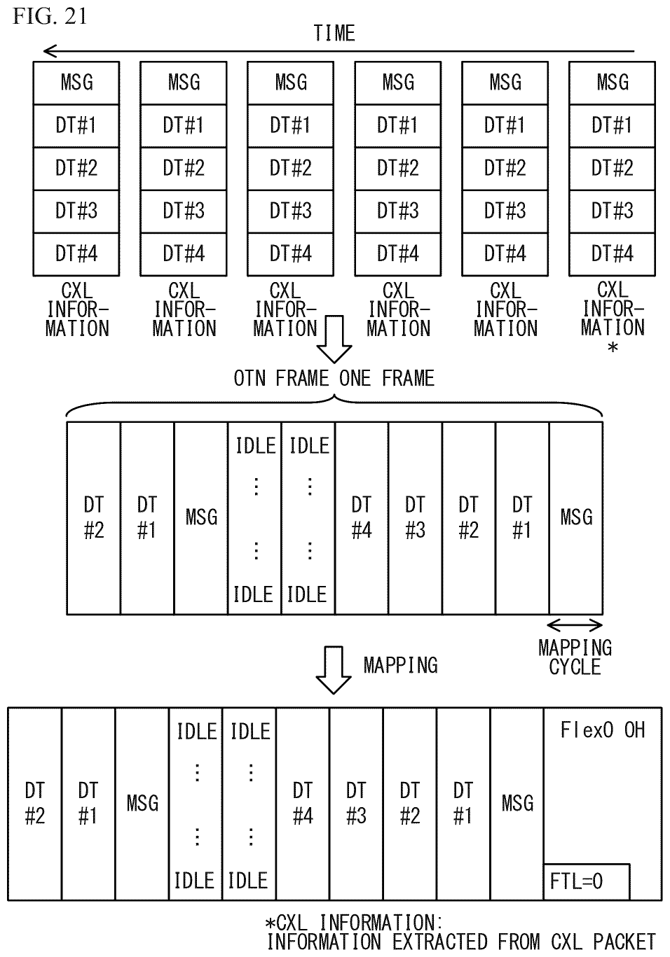

Next, referring to FIGS. 20 and 21, the operation at the time of transmission of the optical transmission device 100 according to the second embodiment will be described.

First, the inputter and outputter 111 extracts the CXL packet from the input client signal (step S41). When the inputter and outputter 111 extracts the CXL packet, the responder 191 transmits the proxy response (step S42). More specifically, when the reception of the CXL packet is notified together with the log data 91 from the inputter and outputter 111, the responder 191 issues the proxy response 92 and transmits it to the server 10. Thus, the server 10 (specifically, the CPU of the server 10) receives the proxy response 92.

For example, when the distance of the optical transmission line 300 through which the optical signal is propagated is long (e.g., several hundred kilometers or several thousand kilometers), the server 10 may take a long time to receive the formal response 93. That is, a delay (latency) in response time occurs. In this case, since the formal response 93 cannot be received, a time-out occurs in the server 10, and the server 10 may misunderstand that a processing error occurs in the writing processing of the write target data. The delay in response time may also induce a decrease in throughput.

However, according to the present embodiment, the responder 191 transmits the proxy response 92 instead of the formal response 93 before the server 10 receives the formal response 93, and the server 10 receives the proxy response 92. This reduces the possibility of the time-out occurring in the server 10, and suppresses the occurrence of the processing error. Further, it is also possible to suppress the decrease in throughput.

When the responder 191 transmits the proxy response 92, the compressor 156 compresses the CXL packet (step S43). More specifically, as described above, the compressor 156 extracts the tag data and the address data stored in the tag area 81 in the message area 80, and generates the compressed packet in which the extracted tag data and address data are used as the new message data.

When the compressor 156 compresses the CXL packet, the mapper 162 executes the mapping processing (step S44). The mapping processing according to the second embodiment is a processing of mapping the message data, which is included as the CXL information in the compressed packet obtained by compressing the CXL packet, and the write target data in the OTN frame instead of the TLP data described in the first embodiment (see FIGS. 6, 9, and 10), as illustrated in FIG. 21. Therefore, the details of the mapping processing according to the second embodiment will be omitted.

When the mapper 162 completes the mapping processing, the digital coherer 114 converts the OTN frame into the optical signal (step S45) and transmits the optical signal (step S46). When the optical signal is transmitted, the optical transmission device 100 ends the operation at the time of transmission. Thus, the optical signal is transmitted from the optical transmission device 100, and the optical transmission device 200 receives the optical signal.

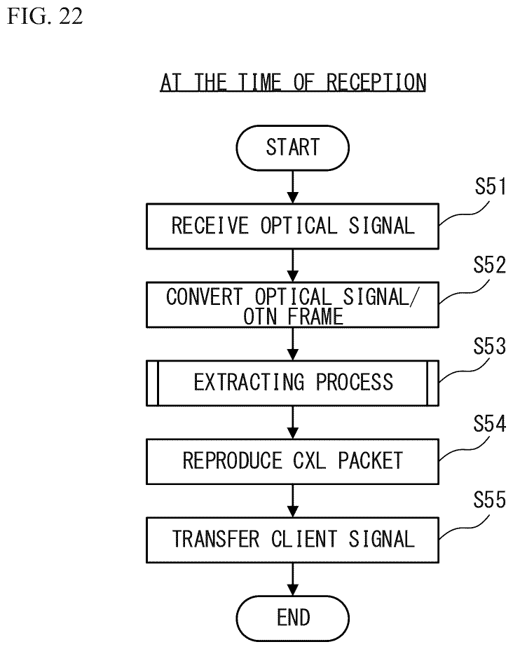

Next, referring to FIG. 22, the operation at the time of reception of the optical transmission device 100 according to the second embodiment will be described. The operation at the time of reception of the optical transmission device 200 is basically the same as the operation at the time of reception of the optical transmission device 100.

First, the digital coherer 114 receives the optical signal transmitted from the optical transmission device 200 (step S51). Upon receiving the optical signal, the digital coherer 114 converts the optical signal into the OTN frame (step S52). When the digital coherer 114 converts the optical signal into the OTN frame, the extractor 171 executes the extraction processing (step S53). The extraction processing according to the second embodiment is a processing of extracting the message data as the CXL information and the write target data as the compressed packet from the OTN frame, instead of the TLP data described in the first embodiment (see FIGS. 12 to 15). Therefore, the details of the extraction processing according to the second embodiment will be omitted.

When the extractor 171 completes the extraction processing, the reproducer 180 reproduces the CXL packet (step S54). For example, the compressor 156 adds a fixed value (i.e., 64 bits) of the restoration data corresponding to the number of bits of the message data excluded from the extraction target to the compressed packet, so that the restorer 181 restores the CXL packet.

When the reproducer 180 reproduces the CXL packet, the inputter and outputter 111 transfers the client signal (step S55), and ends the operation. More specifically, the inputter and outputter 111 receives the CXL packet as the client signal and transfers the client signal to the server 10. In this way, the server 10 receives the client signal transmitted from the server 20.

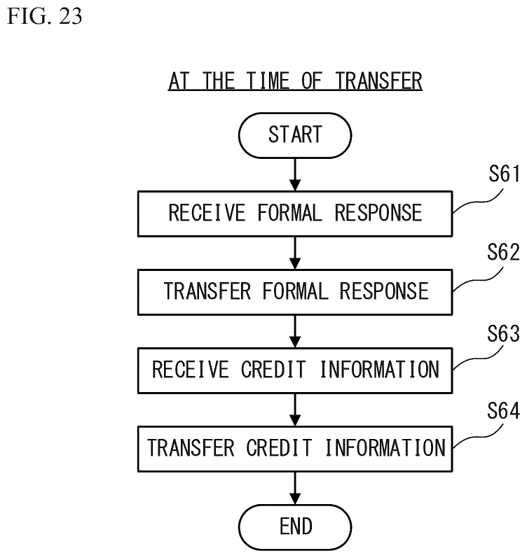

Next, referring to FIG. 23, the operation at the time of transfer of the optical transmission device 200 according to the second embodiment will be described.

For example, when the writing processing of the write target data stored in the CXL packet is completed and the server 20 issues and transmits the formal response 93, an inputter and outputter (not illustrated) provided in the transmitter of the optical transmission device 200 receives the formal response 93 (step S61). The formal response 93 includes the tag data stored in the tag area 81 in the message field 80 of the CXL packet. Upon receiving the formal response 93, the inputter and outputter of the optical transmission device 200 transfers the formal response 93 to a digital coherer (not illustrated) provided in the transmitter of the optical transmission device 200 (step S62). When the digital coherer of the optical transmission device 200 receives the formal response 93, the digital coherer converts the formal response 93 from the electric signal to the optical signal and transmits the optical signal through the optical transmission line 300. Thus, the digital coherer 114 of the optical transmission device 100 receives the formal response 93.

After the server 20 issues the formal response 93, the server 20 issues and transmits the credit information, and the inputter and outputter of the optical transmission device 200 receives the credit information (step S63). Upon receiving the credit information, the inputter and outputter of the optical transmission device 200 transfers the credit information to the digital coherer of the optical transmission device 200 (step S64), and ends the operation. The digital coherer of the optical transmission device 200 converts the credit information from the electric signal to the optical signal and transmits the optical signal through the optical transmission line 300, so that the digital coherer 114 of the optical transmission device 100 receives the credit information.

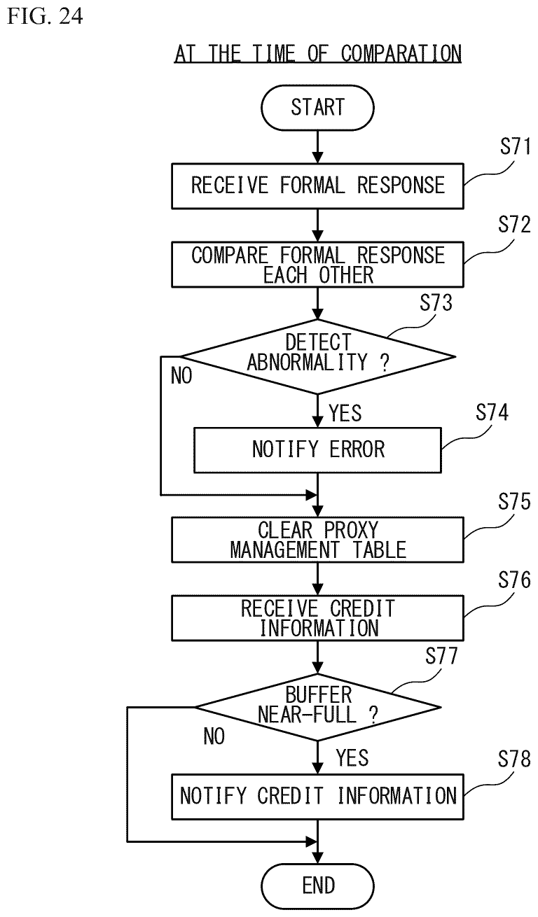

Next, referring to FIG. 24, the operation of at the time of comparing the optical transmission device 100 according to the second embodiment will be described.

As described above, when the digital coherer of the optical transmission device 200 transmits the formal response 93, the digital coherer 114 of the optical transmission device 100 receives the formal response 93 (step S71). When the digital coherer 114 receives the formal response 93, the responder 191 compares responses (step S72). More specifically, when the responder 191 receives the formal response 93 transferred from the digital coherer 114, the responder 191 compares the formal response 93 with the proxy response 92 based on the commonality between the tag data included in the formal response 93 and the tag data stored in the key data item of the log comparing table 193 (see FIG. 19B), and specifies any of the proxy management data.

When any of the proxy management data is specified, the responder 191 updates the flag value stored in the item of the active flag of the log comparing table 193 based on the predetermined identifier included in the formal response 93. For example, when it is determined that an abnormality has occurred in the writing processing, the responder 191 updates the flag value “1” to the flag value “NULL”. On the other hand, when it is determined that no abnormality has occurred in the writing processing, the responder 191 updates the flag value “1” to the flag value “0”.

Thereafter, the responder 191 determines whether or not the abnormality is detected (step S73). For example, when the responder 191 confirms that the flag value “0” is stored in the item of the active flag of the log comparing table 193, the responder 191 determines that the relationship between the formal response 93 and the proxy response 92 is normal and that no abnormality is detected (step S73: NO). On the contrary, when the responder 191 confirms that the flag value “NULL” is stored in the item of the active flag of the log comparing table 193, the responder 191 determines that the relationship between the formal response 93 and the proxy response 92 is abnormal and that the abnormality has been detected (step S73: YES).

When the abnormality is detected, the responder 191 notifies an error (step S74). That is, the responder 191 notifies the server 10 of the error of the processing for the CXL packet. Thus, for example, the server 10 can retransmit the CXL packet in which the writing processing has been abnormally performed. If no abnormality is detected, the responder 191 skips the processing of step S74.

Thereafter, the responder 191 clears the proxy management data regardless of whether or not an abnormality is detected (step S75). More specifically, the responder 191 clears the proxy management data associated with the tag data included in the formal response 93 from the log comparing table 193 together with the tag data. This suppresses excessive storage of the proxy management data and its tag data. That is, the log comparing table 193 has a margin for storing data relating to the proxy response 92.

When the responder 191 clears the proxy management data, the digital coherer 114 receives the credit information (step S76). As described above, when the digital coherer of the optical transmission device 200 transmits the credit information, the digital coherer 114 of the optical transmission device 100 receives the credit information. The digital coherer 114 may receive the credit information before the responder 191 clears the proxy management data.

When the digital coherer 114 receives the credit information, the adjuster 192 determines whether the buffer 163 is near-full (step S77). That is, upon receiving the credit information transferred from the digital coherer 114, the adjuster 192 determines whether or not the credit information indicates a state in which the storage amount of the OTN frame stored in the buffer 163 is equal to or larger than the threshold storage amount.

When the buffer 163 is near-full (step S77: YES), the adjuster 192 notifies the credit control (step S78), and ends the operation. Thus, the server 10 adjusts the transmission rate of the CXL packet. As a result, it is possible to avoid the overflow in which the OTN frame exceeds the storage limit of the buffer 163. If the buffer 163 is not near-full (step S77: NO), the adjuster 192 skips the processing of step S78 and ends the operation.

In this way, according to the second embodiment, the optical transmission device 100 transmits the proxy response 92 to the server 10 before receiving the formal response 93 transmitted from the optical transmission device 200. Thus, even if the distance of the optical transmission line 300 is long, the server 10 can avoid the time-out due to the fact that the server 10 does not receive the formal response 93 for a long time.

In the second embodiment, when the formal response 93 includes the predetermined identifier indicating the error in the writing processing, there is a possibility that the relationship between the formal response 93 and the proxy response 92 does not match, but in this case, the optical transmission device 100 notifies the server 10 of the error. Thus, the server 10 can retransmit the CXL packet to be processed, and can recover from the error of the processing.

Furthermore, the optical transmission device 100 can notify the server 10 of the credit control based on the credit information transmitted from the optical transmission device 200. This can prevent the overflow of the OTN frame exceeding the storage limit of the buffer 163. In addition, since the optical transmission device 100 stores the compressed packet obtained by compressing the CXL packet in the OTN frame, the transmission efficiency of the write target data can be improved.

Although the preferred embodiments of the present invention have been described above in detail, the present invention is not limited to the specific embodiments, and various modifications and changes are possible within the scope of the gist of the present invention described in the claims. For example, the proxy response 92 may include the credit information. Thus, the server 10 can grasp the credit status (specifically, the congestion status, the load status, and the like) of the server 20.

What is claimed is:

1. An optical transmission device comprising:
a first processing circuit that deletes, from a plurality of packets, a specific data which does not affect normal transmission and reception of an optical signal obtained by converting a first transmission frame before mapping the plurality of packets into the first transmission frame;
a second processing circuit that maps the plurality of packets into the first transmission frame without using a multiplex hierarchy after removing a padding data stored between the plurality of packets and pre-padding an empty data area by a removal of the padding data with the plurality of packets in order; and
a third processing circuit that converts the first transmission frame in which the plurality of packets are mapped into the optical signal and transmits the optical signal.

2. The transmission device according to claim 1, wherein
the second processing circuit fills a free area of the first transmission frame in which the plurality of packets are mapped with a discard target data, and
the discard target data is discarded by another optical transmission device that faces the optical transmission device and receives the optical signal.

3. The optical transmission device according to claim 1, wherein
the second processing circuit divides a tail packet belonging to the plurality of packets, stores a predetermined value indicating that a single packet mapped at a head of the first transmission frame is an undivided packet into a header of the first transmission frame, and stores the number of bytes of a second half of the tail packet mapped at a head of a second transmission frame continuous to the first transmission frame in a header of the second transmission frame, when the second processing circuit maps a first half of the tail packet into a tail end of the first transmission frame and maps the second half of the tail packet into the head of the second transmission frame.

4. The optical transmission device according to claim 3, wherein
the third processing circuit continuously receives the optical signals, converts the optical signal received first into the first transmission frame in which the plurality of packets are mapped, and converts the optical signal received next into the second transmission frame in which the plurality of packets are mapped, and
the second processing circuit extracts and holds the first half of the tail packet belonging to the plurality of packets from the first transmission frame, extracts the second half of the tail packet belonging to the plurality of packets from the second transmission frame, and then transmits the first half and the second half together to the first processing circuit.

5. The optical transmission device according to claim 4, wherein
the second processing circuit discards the first half of the tail packet to be held when the third processing circuit does not receive the optical signal continuously.

6. The optical transmission device according to claim 1, wherein
all of the plurality of packets are PCI express transaction layer packets (PCIe TLP), and
the transmission frame is an optical transmission network (OTN) frame including a FlexO frame.

7. The optical transmission device according to claim 1, wherein
the first processing circuit transmits to a sever a proxy response instead of a formal response issued by a connecting device of another optical transmission device that faces the optical transmission device when the optical transmission device receives a specific packet according to a compute express link (CXL) protocol from the server.

8. The optical transmission device according to claim 7, wherein
the first processing circuit compares the formal response and the proxy response when the formal response is received from the another optical transmission device, and notifies the server of an error in processing for the specific packet when a relationship between the formal response and the proxy response is abnormal.

9. The optical transmission device according to claim 7, wherein
the first processing circuit monitors a storage amount of a buffer that temporarily stores the first transmission frame until the first transmission frame is converted into the optical signal, and notifies the server of credit control requesting adjustment of transmission of the specific packet when the storage amount is equal to or greater than a threshold storage amount upon receiving specific information including a processing load of the connection device from the another optical transmission device.

10. The optical transmission device according to claim 7, wherein
the specific packet includes a message area for storing a write destination address of a write target data to be written in a memory of the connection device and a non-write destination address other than the write destination address,
the first processing circuit generates a compressed packet obtained by compressing the specific packet based on an extraction of the write destination address from the message area, and
the second processing circuit maps the compressed packet into the first transmission frame.

11. An optical transmission method comprising:
deleting, from a plurality of packets, a specific data which does not affect normal transmission and reception of an optical signal obtained by converting a first transmission frame before mapping the plurality of packets into the first transmission frame;
mapping the plurality of packets into the first transmission frame without using a multiplex hierarchy after removing a padding data stored between the plurality of packets and pre-padding an empty data area by a removal of the padding data with the plurality of packets in order;
converting the first transmission frame in which the plurality of packets are mapped into the optical signal; and
transmitting the optical signal.
